(19) United States
(12) Patent Application Publication
(10) Pub. No.: US 2008/0291511 A1
(43) Pub. Date: Nov. 27, 2008

(54) AUTOMATIC DOCUMENT FEEDER FOR USE WITH OFFICE DOCUMENT

(75) Inventors: Ping-Hong Kuo, Taoyuan Hsien (TW); Cheng-Ming Liao, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: TECO IMAGE SYSTEM CO., LTD., Taoyuan Hsien (TW)

(21) Appl. No.: 11/872,378

(22) Filed: Oct. 15, 2007

(30) Foreign Application Priority Data
May 25, 2007 (TW) 096118793

(51) Int. Cl. H04N 1/04

(52) U.S. Cl. 358/498

(57) ABSTRACT

An automatic document feeder is used with an office machine including a scanning module and a transparent substrate. The automatic document feeder includes a main body, an arc-shaped plate and multiple elastic pressing members. The arc-shaped plate is fixed on the main body and includes multiple protrusions and multiple openings. The protrusions are sustained against a surface of the transparent substrate to define a gap between the arc-shaped plate and the transparent substrate for allowing the paper to transport therethrough. The elastic pressing members have first ends coupled to the arc-shaped plate and have second ends partially penetrating through the corresponding openings. The elastic pressing members are arranged in a staggered form to press the object passing through the gap such that a scan zone of the object is in close contact with the transparent substrate to be scanned by the scanning line of the canning module.

### FIELD OF THE INVENTION

The present invention relates to an automatic document feeder, and more particularly to an automatic document feeder for use with an office machine. The present invention also relates to an office machine having such an automatic document feeder.

### BACKGROUND OF THE INVENTION

With rapid development of electronic industries, a diversity of office machines such as printers, facsimile machines, copy machines or scanners become essential information apparatuses in offices. For example, image scanners are widely used for scanning objects. The images of the scanned documents are converted into image files, which can be stored in a computer or further processed by the computer. During operation of an image scanner, the light emitted by a light source is projected onto the object to be scanned, the light reflected from the object is then transmitted into a scanning module and processed by an image pickup device such as a charge coupled device (CCD) to complete scanning. In addition, the optical signals reflected from the scanned object are converted into corresponding digital signals to be further processed by the computer.

Recently, an automatic document feeder (ADF) is usually integrated into the image scanner in order to successively scanning many paper sheets at a time. The image scanner having the automatic document feeder is also referred as a sheet-feeding scanner. The automatic document feeder may successively transport the paper sheets across the scanning module of the sheet-feeding scanner to perform the scanning operation. This means of automatically feeding the paper sheets is both time-saving and efficient.

Referring to FIG. 1, a schematic cross-sectional view of a conventional sheet-feeding scanner is illustrated. As shown in FIG. 1, the sheet-feeding scanner 10 principally comprises an automatic document feeder 101, a glass platform 102 and a scanning module 103. The automatic document feeder 101 is arranged above the glass platform 102 and the scanning module 103. The automatic document feeder 101 has a U-shaped plate 1011 at the bottom thereof. There is a gap G between the U-shaped plate 1011 and the glass platform 102, i.e. between the bottom of the automatic document feeder 101 and the glass platform 102. When the object 104 to be scanned (e.g. a paper sheet) passes through the gap G, the object 104 is scanned by the scanning line 105 of the scanning module 103.

Generally, when the object 104 passes through the gap G between the U-shaped plate 1011 and the glass platform 102, the object 104 is readily bent upwardly and swung in the gap G because this object 104 is very thin. If the object 104 fails to lie flat on the glass platform 102 when passing through the scanning line 105, the scanning quality of the sheet-feeding scanner is adversely affected. For preventing the object from rising up when passing through the gap G, the sheet-feeding scanner should be improved.

FIG. 2(a) is a schematic partial perspective view illustrating another conventional sheet-feeding scanner. For clarification, only a pick-up roller assembly 20, some pressing slices 21, an object 22 to be scanned and a scanning module 23 are shown in the drawings. As shown in FIG. 2(a), the pick-up roller assembly 20 includes multiple rollers. A pressing slice 21 is arranged between every two adjacent rollers of the pick-up roller assembly 20. Once the pick-up roller assembly 20 transports the object 22 into the gap between the bottom of the automatic document feeder and the glass platform (not shown), the object 22 is pressed by the pressing slices 21 lie flat on the glass platform. Since the object 22 lie flat on the glass platform when passing through the scanning line 24 of the scanning module 23, the scanning quality of the sheet-feeding scanner is improved.

Although the pressing slices 21 may prevent the object from rising up, there are still some drawbacks. For example, as shown in FIG. 2(a), the tips of the pressing slices 21 are arranged in the same line. That is, the object 22 has an imaginary line 221 overlapping the line constituted by the tips of the pressing slices 21. Ideally, the imaginary line 221 is aligned with the scanning line 24 of the scanning module 23. In a case that the scanning module of the sheet-feeding scanner has a production error or is suffered from a strong impact, the scanning line 24 of the scanning module 23 is possibly shifted. Under this circumstance, the imaginary line 221 may no longer be aligned with the scanning line 24 of the scanning module 23, as is shown in FIG. 2(b). Therefore, the scanning quality of the sheet-feeding scanner is largely deteriorated. In addition, the pressing slices 21 are disadvantageous because it is difficult to control the depressing forces of the pressing slices 21.

Therefore, there is a need of providing an automatic document feeder and an office machine having such an automatic document feeder so as to overcome the disadvantages of the prior art as described above.

### SUMMARY OF THE INVENTION

It is an object of the present invention to provide an automatic document feeder having elastic pressing members, which are arranged in a staggered form to press the object passing through the gap, so that a scan zone of the object is in close contact with the transparent substrate and scanned by the scanning line of the canning module.

Another object of the present invention provides an office machine having such an automatic document feeder so as to enhance the scanning quality.

In accordance with an aspect of the present invention, there is provided an automatic document feeder for use with an office machine to scan an object. The office machine includes a scanning module and a transparent substrate. The scanning module is arranged under the transparent substrate and has a scanning line. The automatic document feeder includes a main body, an arc-shaped plate and multiple elastic pressing members. The arc-shaped plate is fixed on the main body and includes multiple protrusions and multiple openings. The protrusions are sustained against a surface of the transparent substrate to define a gap between the arc-shaped plate and the transparent substrate for allowing the paper to transport therethrough. The openings are communicated with the gap. The elastic pressing members have first ends coupled to the arc-shaped plate and have second ends partially penetrating through the corresponding openings. The elastic pressing members are arranged in a staggered form to press the object passing through the gap such that a scan zone of the object is in close contact with the transparent substrate and scanned by the scanning line of the canning module.

Preferably, the transparent substrate is made of glass material.

Preferably, the arc-shaped plate is U-shaped.

In an embodiment, the elastic pressing members are elastic slices having respective bent parts, which are arranged in a staggered form and partially penetrate through the openings to press the object.

In an embodiment, the openings are arranged in a staggered form, and the elastic pressing members are rollers partially penetrating through the openings to press the object.

Preferably, the object is a paper sheet.

In an embodiment, the protrusions are U-shaped sticks.

Preferably, the office machine is a scanner.

In accordance with another aspect of the present invention, there is provided an office machine for scanning an object. The office machine includes a transparent substrate, a scanning module and an automatic document feeder. The scanning module is arranged under the transparent substrate and has a scanning line. The automatic document feeder includes a main body, an arc-shaped plate and multiple elastic pressing members. The arc-shaped plate is fixed on the main body and includes multiple protrusions and multiple openings. The protrusions are sustained against a surface of the transparent substrate to define a gap between the arc-shaped plate and the transparent substrate for allowing the paper to transport therethrough. The openings are communicated with the gap. The elastic pressing members have first ends coupled to the arc-shaped plate and have second ends partially penetrating through the corresponding openings. The elastic pressing members are arranged in a staggered form to press the object passing through the gap such that a scan zone of the object is in close contact with the transparent substrate and scanned by the scanning line of the canning module.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view of a conventional sheet-feeding scanner;

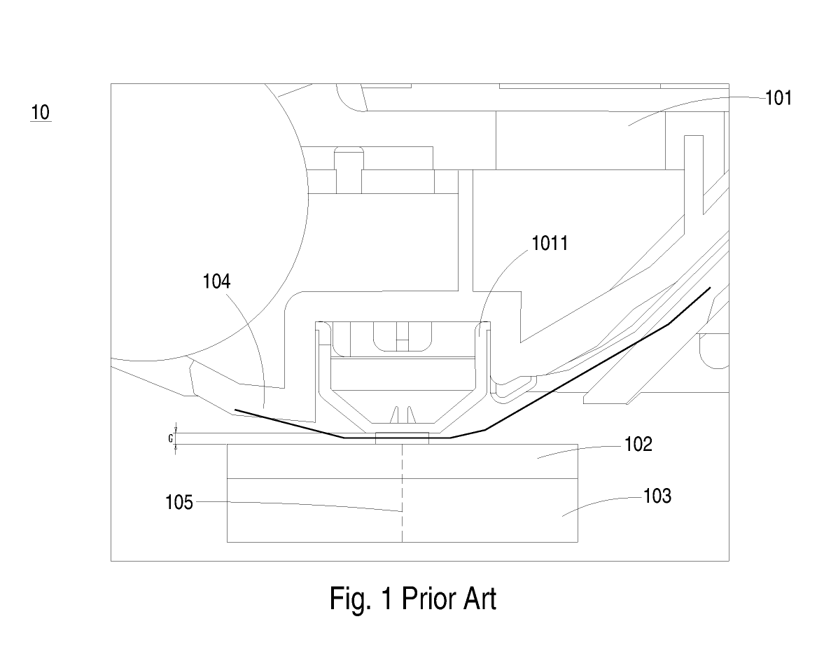

FIG. 2(a) is a schematic partial perspective view illustrating another conventional sheet-feeding scanner;

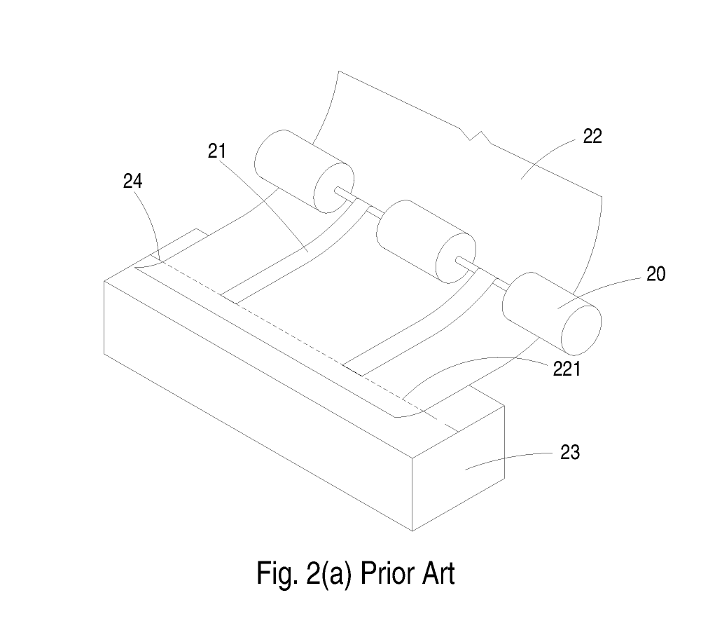

FIG. 2(b) schematically illustrates shift of the scanning line of the sheet-feeding scanner in FIG. 2(a);

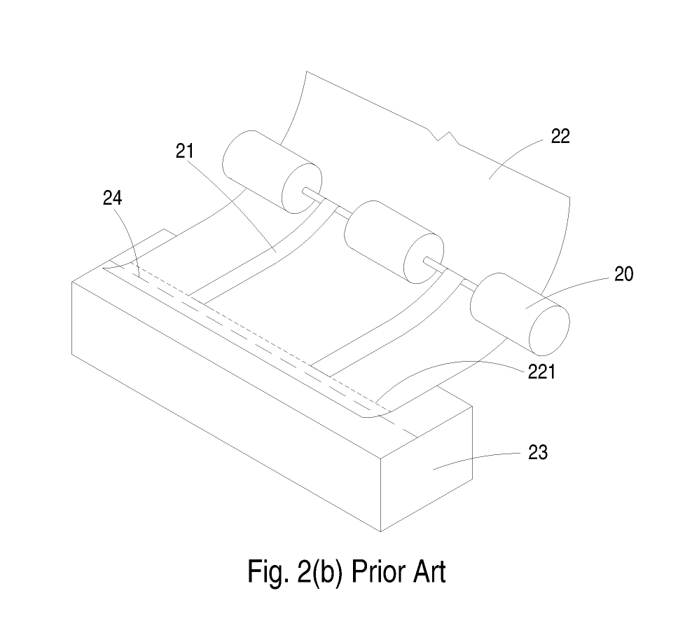

FIG. 3(a) is a schematic bottom view of an office machine according to a first preferred embodiment of the present invention;

FIG. 3(b) is a schematic perspective view illustrating an arc-shaped plate and multiple elastic pressing members used in the sheet-feeding scanner of FIG. 3(a);

FIG. 3(c) is a schematic cross-sectional view of the sheet-feeding scanner of FIG. 3(a) taken from the line A-A as well as the transparent substrate and the scanning module

FIG. 4(a) is a schematic bottom view of an office machine according to a second preferred embodiment of the present invention; and

FIG. 4(b) is a schematic perspective view illustrating an arc-shaped plate and multiple elastic pressing members used in the sheet-feeding scanner of FIG. 4(a).

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

Hereinafter, the office machine of the present invention will be illustrated by referring to a sheet-feeding scanner. Nevertheless, the present invention may be applied to other office machines such as printers, facsimile machines, copy machines or multifunction peripherals.

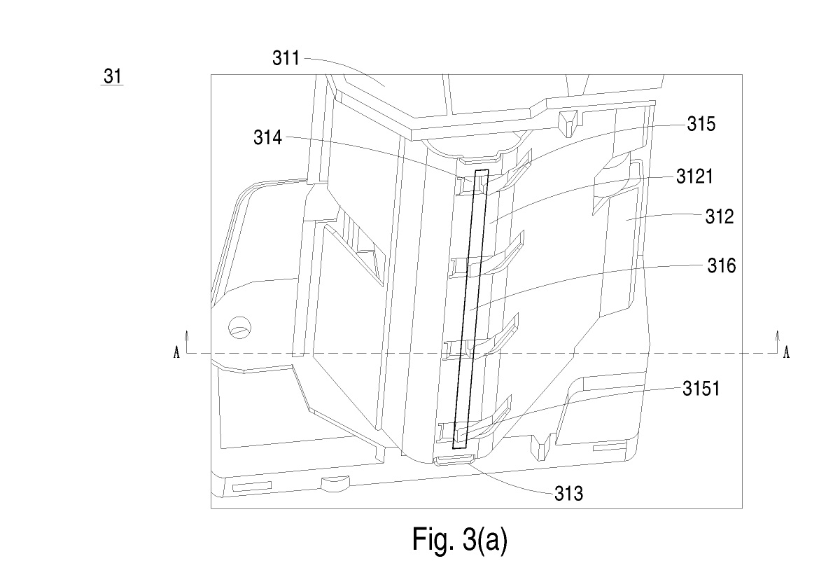

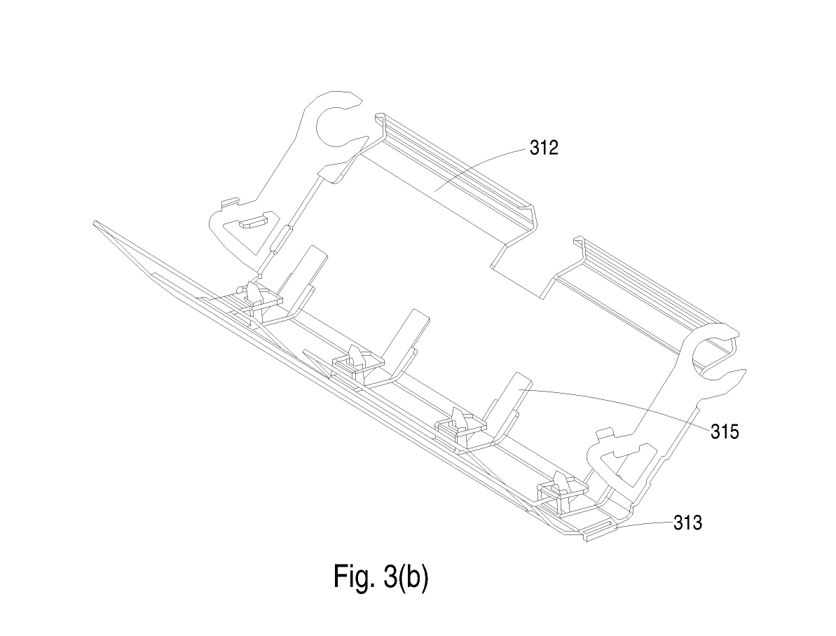

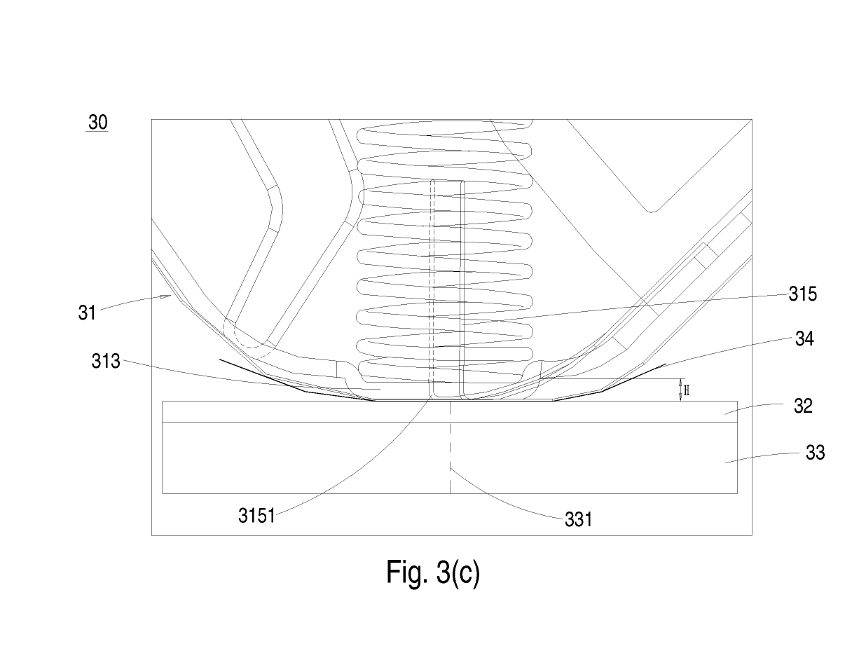

FIG. 3(a) is a schematic bottom view illustrating an office machine according to a first preferred embodiment of the present invention. FIG. 3(b) is a schematic perspective view illustrating an arc-shaped plate and multiple elastic pressing members used in the sheet-feeding scanner of FIG. 3(a). FIG. 3(c) is a schematic cross-sectional view of the sheet-feeding scanner of FIG. 3(a) taken from the line A-A as well as the transparent substrate and the scanning module.

Please refer to FIGS. 3(a), 3(b) and 3(c). The sheet-feeding scanner principally comprises an automatic document feeder 31, a transparent substrate 32 (e.g. a glass platform) and a scanning module 33. By means of the automatic document feeder 31, the object 34 (e.g. a paper sheet) may be fed into the inner portion of the sheet-feeding scanner to be scanned by the scanning module 33.

In this embodiment, the transparent substrate 32 is made of transparent material such as glass. The scanning module 33 is arranged under the transparent substrate 32 and has a scanning line 331 thereon. During operation of the sheet-feeding scanner, the light emitted by a light source is projected onto the paper sheet 34, and the light reflected from the paper sheet 34 is then transmitted into the scanning module 33 and processed by an image pickup device such as a charge coupled device (CCD) to complete scanning.

The automatic document feeder 31 is arranged above the transparent substrate 32 and the scanning module 33. The automatic document feeder 31 principally comprises a main body 311, an arc-shaped plate 312 and multiple elastic pressing members 315. The arc-shaped plate 312 is fixed on the main body 311. Two protrusions 313 are protruded from the bilateral sides of the bottom 3121 of the arc-shaped plate 312 and sustained against the surface of the transparent substrate 32. As a result, a gap H is defined between the bottom 312 of the arc-shaped plate 312 and the transparent substrate 32. The scanning line 331 of the scanning module 33 is located under the bottom 3121 of the arc-shaped plate 312. Once the pick-up roller assembly (not shown) transports the paper sheet 34 into the gap H, the paper sheet 34 is scanned by the scanning line 331 of the scanning module 33. After complete scanning, the paper sheet 34 is ejected from the automatic document feeder 31 by an eject roller assembly (not shown).

In addition, the bottom 3121 of the arc-shaped plate 312 has several openings 314 between these two protrusions 313. These openings 314 are used for accommodating respective elastic pressing members 315. In this embodiment, the elastic pressing members 315 are elastic slices. A first end of each elastic slice 315 is bonded on an inner wall of the arc-shaped plate 312. A second end of each elastic slice 315 is a free end and movable upwardly or downwardly. Each elastic slice 315 has a bent part 3151 protruded through the opening 314 so as to be sustained against the paper sheet 34. In accordance with the feature of the present invention, the bent parts 3151 of these elastic slices 315 are arranged in a staggered form rather than in a line. As a consequence, a scan zone 316 of the paper sheet 34 is pressed by the bent parts 3151 of these elastic slices 315 to lie flat on the glass platform 32 when the paper sheet 34 is transported across the gap H.

When the pick-up roller assembly (not shown) of the automatic document feeder 31 transports the paper sheet 34 into the gap H between the bottom 312 of the arc-shaped plate 312 and the transparent substrate 32, the elastic slices 315 are slightly uplifted due to the thickness of the paper sheet 34. In addition, the paper sheet 34 is also pressed by the weight of the elastic slices 315 such that the scan zone 316 of the paper sheet 34 lies flat on the transparent substrate 32.

As previously described, the scanning line of the scanning module is possibly shifted if the scanning module has a production error or is suffered from a strong impact. According the present invention, since the scan zone 316 of the paper sheet 34 to be in direct contact with the transparent substrate 32 is a plane constituted by several non-linear points (i.e. the bent parts 3151), a tiny or medium shift of the scanning line has minimized influence on the scanning quality.

In the above embodiment, the protrusions 313 are U-shaped sticks. The protrusions 313 may have any shapes so long as they and sustained against the surface of the transparent substrate to define a gap H between the bottom of the arc-shaped plate and the transparent substrate. In addition, the arc-shaped plate 312 is a U-shaped plate. The arc-shaped plate 312 may have any shape so long as it cooperates with the transparent substrate 32 to define the gap for passing the paper sheet 34 therethrough.

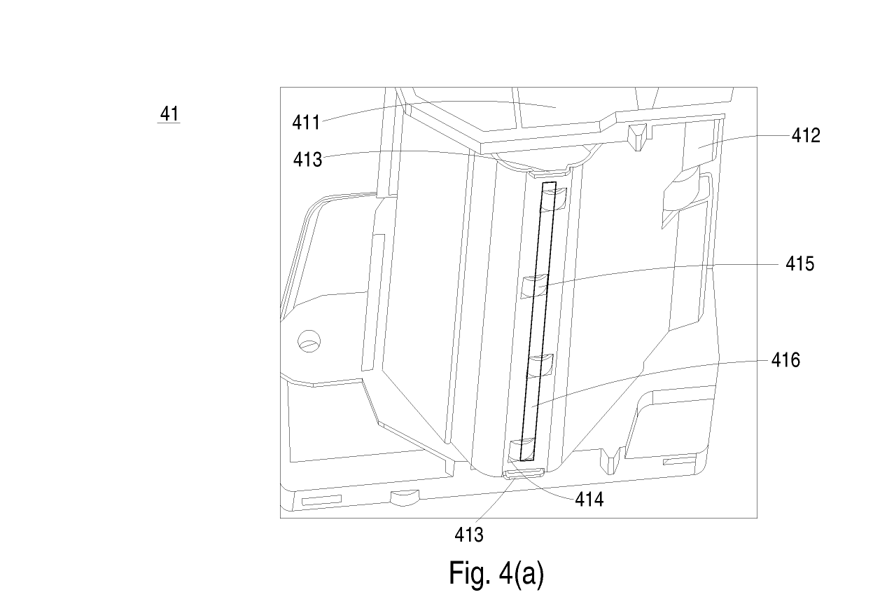

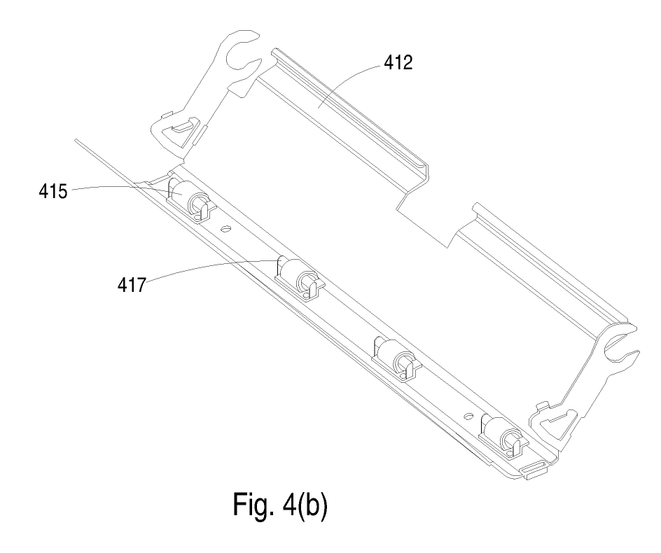

FIG. 4(a) is a schematic bottom view of an office machine according to a second preferred embodiment of the present invention. FIG. 4(b) is a schematic perspective view illustrating an arc-shaped plate and multiple elastic pressing members used in the sheet-feeding scanner of FIG. 4(a). The automatic document feeder 41 is arranged above the transparent substrate (not shown) and the scanning module (not shown). The automatic document feeder 41 principally comprises a main body 411, an arc-shaped plate 412 and multiple elastic pressing members 415. Two protrusions 413 are protruded from the bilateral sides of the bottom of the arc-shaped plate 412 and sustained against the surface of the transparent substrate. As a result, a gap (not shown) is defined between the bottom of the arc-shaped plate 412 and the transparent substrate. The relationships between main body 411, the arc-shaped plate 412, the protrusions 413, the transparent substrate and the scanning module are identical to those shown in FIG. 4, and are not redundantly described herein.

In addition, the bottom of the arc-shaped plate 412 has several openings 414 between these two protrusions 413. Especially, these openings 414 are arranged in a staggered form rather than in a line. More especially, the elastic pressing members 415 are rollers. The bilateral sides of each roller 415 are fixed on the peripheries of the corresponding opening 414 via a resilient fixing element 417. The rollers 415 are movable upwardly or downwardly and sustained against the paper sheet passing through the gap. Since the openings 414 are arranged in a staggered form, these rollers 415 are also arranged in a staggered form.

When the pick-up roller assembly of the automatic document feeder 41 transports the paper sheet into the gap between the bottom of the arc-shaped plate 412 and the transparent substrate, the rollers 415 are slightly uplifted due to the thickness of the paper sheet. In addition, the paper sheet is also pressed by the weight of the rollers 415 such that the scan zone 416 of the paper sheet lies flat on the transparent substrate.

From the above description of the automatic document feeder of the present invention, since the object to be scanned is pressed by the elastic pressing members in a staggered form, the scan zone of the object to be in direct contact with the transparent substrate is a plane constituted by several non-linear points. As a result, a tiny or medium shift of the scanning line has minimized influence on the scanning quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic document feeder for use with an office machine to scan an object, said office machine including a scanning module and a transparent substrate, said scanning module being arranged under said transparent substrate and having a scanning line, said automatic document feeder comprising:
a main body;
an arc-shaped plate fixed on said main body and including multiple protrusions and multiple openings, wherein said protrusions are sustained against a surface of said transparent substrate to define a gap between said arc-shaped plate and said transparent substrate for allowing said paper to transport therethrough, and said openings are communicated with said gap; and
multiple elastic pressing members having first ends coupled to said arc-shaped plate and second ends partially penetrating through said corresponding openings, wherein said elastic pressing members are arranged in a staggered form to press said object passing through said gap such that a scan zone of said object is in close contact with said transparent substrate and scanned by said scanning line of said canning module.

2. The automatic document feeder according to claim 1 wherein said transparent substrate is made of glass material.

3. The automatic document feeder according to claim 1 wherein said arc-shaped plate is U-shaped.

4. The automatic document feeder according to claim 1 wherein said elastic pressing members are elastic slices having respective bent parts, which are arranged in a staggered form and partially penetrate through said openings to press said object.

5. The automatic document feeder according to claim 1 wherein said openings are arranged in a staggered form, and said elastic pressing members are rollers partially penetrating through said openings to press said object.

6. The automatic document feeder according to claim 1 wherein said object is a paper sheet.

7. The automatic document feeder according to claim 1 wherein said protrusions are U-shaped sticks.

8. The automatic document feeder according to claim 1 wherein said office machine is a scanner.

9. An office machine for scanning an object, said office machine comprising:
a transparent substrate;
a scanning module arranged under said transparent substrate and having a scanning line; and
an automatic document feeder comprising:
a main body;
an arc-shaped plate fixed on said main body and including multiple protrusions and multiple openings, wherein said protrusions are sustained against a surface of said transparent substrate to define a gap between said arc-shaped plate and said transparent substrate for allowing said paper to transport therethrough, and said openings are communicated with said gap; and
multiple elastic pressing members having first ends coupled to said arc-shaped plate and second ends partially penetrating through said corresponding openings, wherein said elastic pressing members are arranged in a staggered form to press said object passing through said gap such that a scan zone of said object is in close contact with said transparent substrate and scanned by said scanning line of said canning module.

10. The office machine according to claim 9 wherein said elastic pressing members are elastic slices having respective bent parts, which are arranged in a staggered form and partially penetrate through said openings to press said object.

11. The office machine according to claim 9 wherein said openings are arranged in a staggered form, and said elastic pressing members are rollers partially penetrating through said openings to press said object.

12. The office machine according to claim 9 wherein said object is a paper sheet.

13. The office machine according to claim 9 wherein said protrusions are U-shaped sticks.

14. The office machine according to claim 9 wherein said office machine is a scanner.
